(19) United States
(12) Patent Application Publication
(10) Pub. No.: US 2024/0003424 A1
(43) Pub. Date: Jan. 4, 2024

(54) Non-Contact Self-Impact Seal Efficient in Throttling and Fixed in Clearance

(71) Applicant: JIANGSU OCEAN UNIVERSITY, Lianyungang (CN)

(72) Inventors: Yan WANG, Lianyungang (CN); Yiming HE, Lianyungang (CN); Xu CHEN, Lianyungang (CN); Xuefei XIE, Lianyungang (CN); Hui XU, Lianyungang (CN); Kangjie KONG, Lianyungang (CN); Zhouxin HUANG, Lianyungang (CN)

(21) Appl. No.: 18/351,684

(22) Filed: Jul. 13, 2023

Related U.S. Application Data
(63) Continuation of application No. PCT/CN2023/086810, filed on Apr. 7, 2023.

(30) Foreign Application Priority Data
Jun. 30, 2022 (CN) 202210755254.9

(51) Int. Cl. F16J 15/40; F16J 15/34

(52) U.S. Cl. CPC F16J 15/40; F16J 15/34

(57) ABSTRACT

The application discloses a non-contact self-impact seal efficient in throttling and fixed in clearance. The non-contact self-impact seal is formed by assembling a stationary ring, a rotating ring and hanging pillars; the stationary ring, the rotating ring and the hanging pillars are all rigidly fixed; the hanging pillars are respectively arranged in the stationary ring or the rotating ring according to an assembly relationship; a fluid channel is formed by a non-contact clearance formed after the stationary ring, the rotating ring and the hanging pillars are rigidly fixed; the fluid channel is composed of an inlet, an outlet and a stacked arrangement structure; the non-contact self-impact seal is arranged in a stacked manner, series arrangement can be achieved, the stage arrangement and the throttling efficiency are more efficient, a clearance seal and a labyrinth seal under the same working condition and parameters.

### TECHNICAL FIELD

The application belongs to the technical field of rotating fluid mechanical devices, in particular to a non-contact self-impact seal efficient in throttling and fixed in clearance.

### BACKGROUND

With the progress of science and technology and the development of industry, the practical requirements for mechanical seals under high parameters are becoming higher and higher. The latest American Petroleum Institute (API)-682 standard stipulates that a seal system must operate continuously and stably for at least 3 years (25000 h). The limitations of traditional mechanical seals under high parameters are becoming increasingly prominent, namely high power consumption, severe wear and limited service life. Non-contact mechanical seals based on hydrodynamic lubrication have the characteristics of zero leakage, low power consumption and long service life, and are developing extremely rapid. The high-performance non-contact mechanical seals have been taken as a key direction for advanced seal technology research and development at home and abroad. As early as 2012, the non-contact seals represented by brush type and dry gas seals have been listed as “advanced gas turbine sealing and leakage control strategies” in the United States, and successfully replaced the original mechanical seal for a PW2000 engine for thousands of hours of test flights. A large amount of domestic researchers have been committed to the technology promotion, theoretical research and product localization of the non-contact mechanical seals, but high-performance seal products still depend on imports, and are limited in the supply cycle and quantity, which seriously restricts the development and application of high-end device technologies.

The research status of non-contact mechanical seal technologies at home and abroad is that in the 1950s, due to the development requirements for the atomic energy industry, there was an urgent need for mechanical seals with a high PV value, and the structure in the form of a hydrostatic pressure, dynamic pressure and thermal hydrodynamic pressure based non-contact seal appeared. By the 1960s, various types of static pressure and dynamic pressure seals had been gradually applied in industry. Driven by the demand for aerospace and nuclear power, new sealing materials such as silicon carbide and high-quality carbon graphite appeared in the 1970s, and multi-stage and combined seals such as spiral, floating-ring and spiral groove seals emerged. Since the 1980s, the increasing demand for environmental protection has led to the introduction of various new standards (API610, API682, Society of Tribologists and Lubrication Engineers (STLE) SP-30, etc.). Laser processing, surface modification, computer technology, etc., have effectively promoted the theoretical progress and performance improvement of the non-contact mechanical seals. Achieving zero leakage and zero emission of a medium are significant characteristics of the non-contact seals, but the specific leakage suppression methods and mechanisms are not the same, and the research status of four representative non-contact mechanical seal technologies are analyzed separately below.

(1) Labyrinth Seals

The labyrinth seal is an effective seal structure widely used in modern power machinery such as aircraft engines and turbines, and has the characteristics of simple structure, no friction, long service life, and convenient maintenance. The main mechanism of action of the labyrinth seal is a throttling process of a sealing tip clearance and a kinetic energy dissipation process of a cavity between teeth, specifically including four types of effects: friction, flow rate contraction, permeability and thermodynamics. The thermodynamic effect is the main reason for the labyrinth seal, the frictional effect is conducive to the sealing effect, and the fluid contraction and permeability effects will weaken the sealing effect. In the 1980s, an MK-152 engine used by China's civil aviation was replaced in advance due to excessive oil consumption, and the fuel consumption directly decreased by 40.7% after the labyrinth seal was used. The Aptitude Scholastic Test (AST) program implemented by National Aeronautics and Space Administration (NASA) in the 1990s showed that for every 10% of reduction in a fuel consumption rate of the aircraft engine, 2% to 3% came from improvements in a labyrinth sealing technology. The practical application of a China's new fighter engine also shows that the working efficiency can be significantly increased by 10% by reasonably improving the sealing performance of the labyrinth seal. However, at present, the labyrinth seal still has the defects, mainly manifested in that the permeability effect is significant, the energy of the sealed medium cannot be fully dissipated, and the sealing efficiency is continuously lost; and the airflow excitation problem occurs under the high parameters, which easily causes the instability of a seal rotor system and reduces the sealing stability.

(2) Dry Gas Seal

A dry gas seal technology based on the principle of dynamic and static pressure has the characteristics of low wear, long service life and zero leakage, and is very suitable for high speed occasions. In the 1960s, the NASA, Pratt & Whitney Aircraft (PWA) and General Electric Company (GE) have begun to explore the use of this technology for high-slip key parts of the aircraft engine. John Crane has launched a series of dry gas seal products that have been widely used in compressors, turbines, and industrial pumps. Since the introduction of this technology in China in 1990s, universities such as Tsinghua University, Xi'an Jiaotong University, Beihang University and Harbin Institute of Technology have carried out a large amount of theoretical and experimental research, which has effectively promoted the localization of such technologies. In terms of industrial development, companies such as Sinoseal, Sinomarch and Hefei General Machinery Research Institute have also developed a series of products that have been well applied. However, there is still a certain gap compared to foreign countries, especially in the field of high-performance products. At present, the maximum working pressure of foreign dry gas seal products can reach 10000 psi (about 69 MPa), and the linear speed can reach 250 m/s (at 65 MPa). The maximum pressure of the domestic dry gas seals in field application is about 25 MPa, and the corresponding linear speed is also within 230 m/s. Moreover, it is difficult for a single set of dry gas seals to meet the leakage requirements under the influence of the permeability effect, a plurality of sets of seals are often combined in practice, the thickness of a gas film during normal operation is only about 2-5 μm, and the stability of a mesoscale gas film and a system is also not optimistic. In addition, the core technology of the dry gas seal lies in the precision machining of a groove profile of 3-10 μm (Ra<0.8 μm), and such efficient precision preparation method has always been blocked by foreign technology.

(3) Upstream Pumping Seal

The upstream pumping seal is derived from a gas-lubricated bearing technology and is mostly used for liquid media. By pumping a sealing medium from a low-pressure side to a high-pressure side, low or even zero leakage can be achieved in a non-contact state. In 1981, the first patent technology for the upstream pumping seal was approved. Since the 1990s, the research on this technology has gradually increased, the leakage suppression ability of a spiral groove profile has been proved to be more ideal, and a series of products have been developed and successfully applied in industry. In 2014, Smith designed a new upstream pumping seal having an anti-fouling effect and proved the reliability of an apparatus according to the cases. In 2018, Warda, et al. proposed a bidirectional integral pumping seal apparatus having a good sealing effect. The first domestic parent for the upstream pumping seal was approved in 1990. At present, the teams such as Wang Yuming from Tsinghua University, Hao Muming from China University of Petroleum, Song Pengyun from Kunming University of Science and Technology, Zhu Weibing from Xihua University and Chen Huilong from Jiangsu University have done a lot of helpful explorations on the upstream pumping seal from theoretical analysis and experimental research. At present, the upstream pumping mechanical seal is mostly used in the occasions with low speed (<3000 rpm), in the multi-working conditions and reverse rotation environments, the dynamic pressure effect is not obvious and is a prominent problem, and when severe, a seal ring is worn, resulting in seal failure.

(3) Magnetic Fluid Seal

The world's first patent for the magnetic fluid seal was proposed by American scientist Rosensweig in 1948, and then the scientists have done a great deal of research on magnetohydrodynamic and thermodynamic properties, preparation processes, etc., centering around the sealing function. The proposal of a combined magnetic fluid seal structure [i] effectively improves the pressure resistance of the seal. The technologies such as multi-lip/internal and external seal cooling pipes and Peltier semiconductor refrigeration further enhance the high temperature resistance of the magnetic fluid seal. A split magnetic fluid seal successfully solves the problems of assembly and replacement of the seal in a complex device. In the 1970s, foreign scholars began to study the problem of sealing liquid with magnetic fluid, and the results showed that the application speed of the magnetic fluid seal in a liquid environment is not high. Domestic scholars have also done a great deal of research on magnetic fluid liquid medium seals. Li Decal from Beijing Jiaotong University, Li Wenchang from Beijing University of Chemical Technology, Gu Jianming from Shanghai Jiao Tong University have done in-depth research on the structure and force of the magnetic fluid seals. On the whole, when the magnetic fluid is used for sealing the gas, the high pressure resistance, the high temperature resistance and the ability to withstand the linear velocity are not high, especially for sealing the liquid, the sealing performance is greatly affected by the spindle speed, so that the magnetic fluid seal is only suitable for low speed (<1500 rpm is better). So far, the principle and a failure mechanism for sealing the liquid with the magnetic fluid are not completely clear.

It can be seen from the above that the non-contact mechanical seals are still imperfect, specifically manifested as follows: (1) most seal structures have a through-type permeability effect, resulting in large leakage and low sealing efficiency (such as the labyrinth, dry gas, spiral and clearance seals); (2) excessive dependence on the spindle speed causes the loss of the sealing ability during the start-stop stage (such as the dry gas, centrifugal and upstream pumping seals); (3) the adaptability to high-speed or high-pressure conditions is weak (such as the magnetic fluid and spiral seals); and (4) auxiliary apparatuses are complex and the system stability is poor (such as dry gas, upstream pumping and spiral seals). Despite the above defects, non-contact seal methods without solid phase friction are still the best method for achieving the sealing under high parameter working conditions. If the sealing and throttling efficiency can be improved by innovative fluid blocking mechanisms based on non-contact operation, the excessive dependence on the spindle speed or speed restrictions on the sealing performance is avoided, while the characteristics such as simple structure and high stability are also considered, which can yet be regarded as a technological innovation in the field of the non-contact seals.

### SUMMARY

The application aims to design a non-contact self-impact seal efficient in throttling and fixed in clearance, which has the advantages of being stable in sealing clearance, incapable of depending on the spindle speed, efficient in throttling, simple in structure and concise in system.

In order to achieve the above purposes, the application adopts the following technical solution.

A non-contact self-impact seal efficient in throttling and fixed in clearance is provided. The non-contact self-impact seal is formed by assembling a stationary ring, a rotating ring and hanging pillars. The stationary ring, the rotating ring and the hanging pillars are all rigidly fixed. The hanging pillars are respectively arranged in the stationary ring or the rotating ring according to an assembly relationship. A fluid channel is formed by a non-contact clearance formed after the stationary ring, the rotating ring and the hanging pillars are rigidly fixed. The fluid channel is composed of an inlet, an outlet and a stacked arrangement structure, the stacked arrangement structure being composed of a plurality of self-impact units, and each self-impact unit specifically including a fluid channel body. A first bifurcated opening of the fluid channel is divided into an oblique channel and a bent channel, and the bent channel is intersected with the oblique channel again to form a second bifurcated opening after large turning.

Further, the arrangement of the self-impact units is composed of one or more combinations of symmetrical, positive staggered and negative staggered arrangements according to an arrangement relationship of the adjacent first bifurcated opening and the second bifurcated opening. Experimental research shows that the positive staggered structure has a better leakage suppression effect.

Further, the stacked arrangement structure is specifically composed of the plurality of self-impact units through a series combination, and the series combination includes single-column or multi-column arrangement styles.

Further, in the double-column arrangement, the stationary ring is designed into two parts that are connected by bolts or an interference fit, the middle is sealed with a seal ring, it is decided whether the hanging pillars are arranged in the rotating ring or the stationary ring from the perspective of facilitating the assembly, the entire assembly is axially completed in sequence, and during the multi-column arrangement, the stationary ring and the rotating ring are further split, and are connected in series as a whole.

Further, during assembly, the rotating ring is rigidly fixed to a shaft or a shaft sleeve by a set screw or a key or an interference fit connection, and the stationary ring is rigidly fixedly connected to a gland or a body by an anti-rotating pin or a key or an interference fit connection.

Further, through the adoption of the single-column, double-column or multi-column structural arrangement styles, the stationary ring and the rotating ring are axially mounted on the shaft or the shaft sleeve in sequence, or the seal is assembled as a whole, and then is directly mounted on the shaft or the shaft sleeve.

Compared with the traditional seal, the non-contact self-impact seal proposed by the technology has the following outstanding advantages.
(1) The sealing clearance is stable, that is, the rotating ring and the stationary ring of the non-contact self-impact seal are rigidly fixed, which maintains stable and large clearance non-contact operation during operation, and greatly improves the dynamics properties of a sealing pair against the axial/radial vibration.
(2) The non-contact self-impact seal does not depend on the spindle speed, that is, the non-contact self-impact seal forms a stage-by-stage throttling and leakage suppression effect on a sealing medium through the impact blocking of the fluid in a three-dimensional Tesla valve channel. Theoretically, the number of stages and a sealing distance are the key factors to achieve standard leakage or even zero leakage, and the leakage suppression effect is basically unaffected by the spindle speed. The research shows that when the speed increases from 5000 rpm to 50000 rpm under certain working conditions, the leakage increment does not exceed 3%.
(3) The structure is simple and the system is concise, that is, the non-contact self-impact seal has fewer parts and simple structure, in order to save space, the stationary ring also directly depends on a sealing cover or shell, and because the performance is not limited by the spindle speed, the system does not need complex parking auxiliary apparatuses.
(4) The stacked structure has diverse arrangements and is efficient. The hanging pillars are respectively arranged on the corresponding rotating ring and stationary ring to realize the simple assembly of the hanging pillars.

### BRIEF DESCRIPTION OF THE DRAWINGS

FIG. 1 is a schematic diagram of a single-column stacked structure of a non-contact self-impact seal.

FIG. 2 is an arrangement diagram of symmetrical self-impact units.

FIG. 3 is an arrangement diagram of positive staggered self-impact units.

FIG. 4 is an arrangement diagram of negative staggered self-impact units.

FIG. 5 is a schematic diagram of a double-column combination.

FIG. 6 is a schematic diagram of a multi-column series combination.

FIG. 7 is an assembly diagram of a single-column structure.

FIG. 8 is an assembly diagram of a multi-column structure.

FIG. 9 is a diagram of an influence rule of a staggered ratio on seal leakage.

FIG. 10 is a structural diagram of five typical non-contact seals.

FIG. 11A is a schematic diagram of a stacked structure of AbbA.

FIG. 11B is a schematic diagram of a stacked structure of AbBa.

FIG. 11C is a schematic diagram of a stacked structure of aBBa.

FIG. 11D is a schematic diagram of a stacked structure of aBbA.

FIG. 11E is a 4-stage sealing structure corresponding to the stacked structure of AbbA.

FIG. 11F is a 6-stage sealing structure corresponding to the stacked structure of AbbA.

FIG. 11G is a 8-stage sealing structure corresponding to the stacked structure of AbbA.

FIG. 11H is a 10-stage sealing structure corresponding to the stacked structure of AbbA.

In the figures:

1. Stationary ring; 2. Rotating ring; 3. First bifurcated opening; 4. Second bifurcated opening; 5. Bent channel; 6. Oblique channel; 7. Hanging pillar.

### DETAILED DESCRIPTION OF THE EMBODIMENTS

The application is further described below with reference to the drawings.

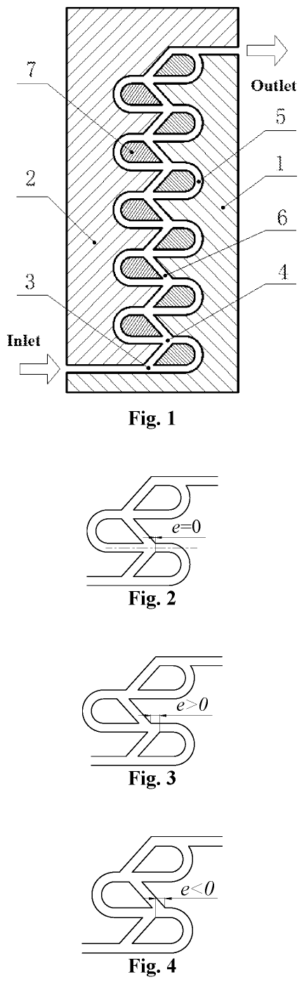

As shown in FIG. 1, a stationary ring 1 and a rotating ring 2 specifically adopt a single-column stacked arrangement structure. A non-contact self-impact seal is formed by assembling the stationary ring 1, the rotating ring 2 and hanging pillars 7. It is decided whether the hanging pillars are arranged in the rotating ring or the stationary ring from the perspective of facilitating the assembly. The stationary ring, the rotating ring and the hanging pillars are all rigidly fixed. The hanging pillars are respectively arranged in the stationary ring or the rotating ring according to an assembly relationship. A fluid channel is formed by a non-contact clearance formed after the stationary ring, the rotating ring and the hanging pillars are rigidly fixed. The fluid channel is composed of an inlet, an outlet and a stacked arrangement structure, the stacked arrangement structure being composed of a plurality of self-impact units, and each self-impact unit specifically including a fluid channel body. A first bifurcated opening 3 of the fluid channel is divided into an oblique channel 6 and a bent channel 5, and the bent channel is intersected with the oblique channel again to form a second bifurcated opening 4 after large turning. The structure has a high radial arrangement efficiency, and the stacked arrangement structure is also designed into symmetrical, positive staggered, negative staggered and other forms. Specifically corresponding to FIG. 2, FIG. 3 and FIG. 4, FIG. 2 shows a symmetrical arrangement of the self-impact units, the structure of which is that the bifurcated openings of the adjacent self-impact units are shared. In FIG. 2, the second bifurcated opening of the lower self-impact unit and the first bifurcated opening of the upper self-impact unit are shared. FIG. 3 and FIG. 4 show a staggered arrangement of the self-impact units, and the second bifurcated opening of the lower self-impact unit and the first bifurcated opening of the upper self-impact unit are staggered in front and back.

As can be seen from the above, the specific position of the fluid channel is determined by a staggered value. Considering the influence of a sealing distance h, a staggered ratio k=e/h (e is the staggered value) is defined as a dimensionless characterization value that measures the amount of positive and negative staggered stage units. FIG. 9 shows an influence rule of changes in a staggered ratio on seal leakage under different sealing distances. It can be seen that the seal leakage is the largest when the negative staggered arrangement is adopted and is always at a high level, possibly due to the lag of fluid reflux caused by the negative staggered arrangement. No staggered arrangement means that the leakage is between the negative staggered arrangement and the positive staggered arrangement when k=0, and then with the increase of a positive staggered ratio, the leakage amount shows a trend of first decreasing and then increasing. The trends are similar under different sealing distances, and the leakage is the smallest when the staggered ratio k=2 (the staggered value is twice the sealing distance). In general, the staggered ratio has a greater impact on the seal leakage, and the positive staggered arrangement is conducive to improving a leakage suppression effect. When the staggered ratio k=2, the lowest leakage is achieved without making a seal stage unit too wide.

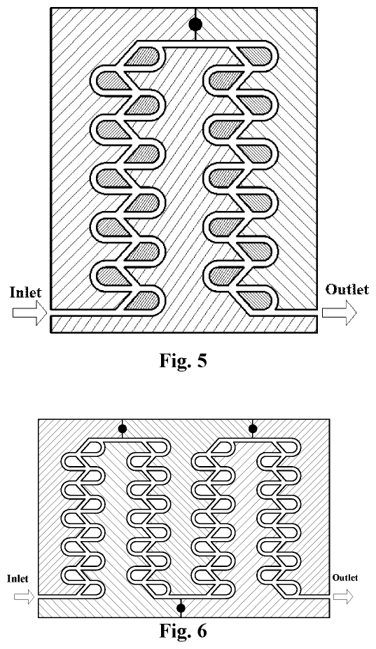

Based on the above basic structural characteristics, a series combined structure is designed. Increasing the seal stage impact unit is an effective means to improve the leakage suppression effect and reduce leakage. According to the single-column stacked design, the more the stages, the larger the axial size of the seal, and the areas of an inlet and an outlet (ring) on both sides of the seal are different. The actual use space of the seal is severely limited. In order to solve this problem, the seal stages are axially arranged under a certain radial size through the double-column or multi-column combination design. As shown in FIG. 5 and FIG. 6, the stationary ring is further designed into two parts that are connected by bolts or an interference fit, the middle is sealed with a seal ring, the assembly of the three parts of the rotating ring and the stationary ring is completed in sequence, and the multi-column combinations are connected in series according to the double-column form.

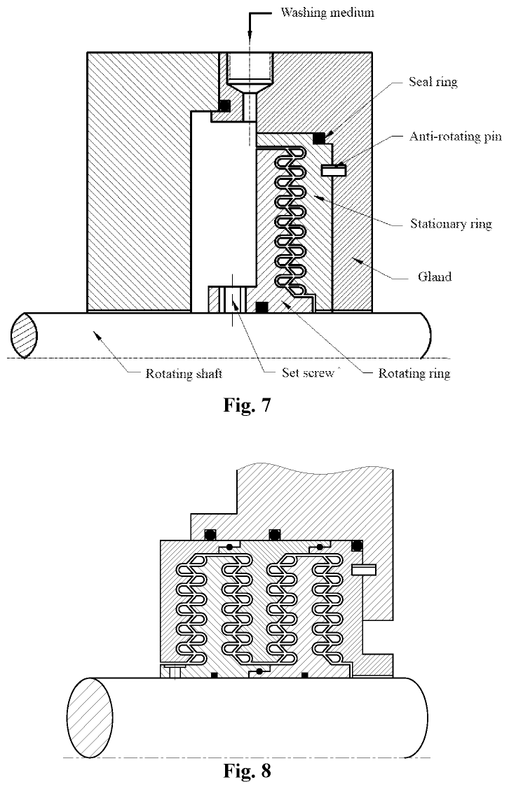

As described above, a model structure is in the single-column form when the axial space is limited and the radial space is abundant, as shown in FIG. 7. The rotating ring is fixed to a shaft or a shaft sleeve by a set screw, the stationary ring is fixedly connected to a gland through an anti-rotating pin, and the other leakage parts are statically sealed by the seal ring. If the sealing gas is dirty, a high-pressure washing medium is introduced to impact an inlet end to ensure that the fluid is clean.

FIG. 8 shows an assembly form of a multi-column structure, which fully utilizes the axial dimension space and is suitable for occasions where the radial space is insufficient. The rotating ring and the stationary ring are mounted from right to left in sequence, and the seal is assembled as a whole according to the actual situation, and then directly mounted to the shaft or the shaft sleeve.

The newly-established non-contact self-impact seal efficient in throttling and fixed in clearance belongs to a passive fluid control blocking sealing technology. When the fluid flows in a flow channel, it experiences the internal impact of a fluid pulse after passing through one stage of the flow channel, and the fluid energy is internally consumed stage by stage. This structure is based on a flat Tesla valve, and by expanding the flat Tesla valve structure to a form of a three-dimensional cylinder channel, seal structure parts are simple and do not contain additional moving parts, the structure belongs to a non-contact mechanical seal, has no direct contact in solid phase, has the characteristics of low power consumption and low wear, and is suitable for high-speed occasions.

In terms of sealing form, the new seal has an energy conversion mechanism with a leakage suppression function: (1) the fluid has a frictional effect at high speed, and the kinetic energy is dissipated by being converted into heat energy, which is conducive to leakage suppression (same as labyrinth, clearance, spiral, dry gas seals, etc.); (2) an impact blocking effect is more significant, a direct convection impact blocking effect of each single stage of seal in a closed system without pressure difference makes the throttling efficiency more prominent (same as upstream pumping, spiral, dry gas seals, etc.), and the kinetic energy of the fluid is rapidly converted into the heat energy and dissipated; (3) contraction is generated during the intersected impact of the fluids, which causes a decrease in pressure and an increase in velocity of the fluid flowing to a low pressure direction, and converts the pressure into the kinetic energy, that is, a beam contraction effect (same as labyrinth, spiral seals, etc.); and (4) after the intersected impact, the velocity direction of some fluids change to drive the fluid in the channel to form a vortex at the intersection, and after continuous expansion and compression, the kinetic energy of the gas is converted into the heat energy and dissipated, that is, a thermodynamic effect (same as labyrinth, spiral, dry gas seals, etc.). The impact blocking effect is the main reason for the new seal to suppress leakage, the throttling is efficient, and can be achieved stage by stage, and there is no significant permeability effect common to most non-contact seals, which is conducive to greatly improving the energy dissipation efficiency of the fluid.

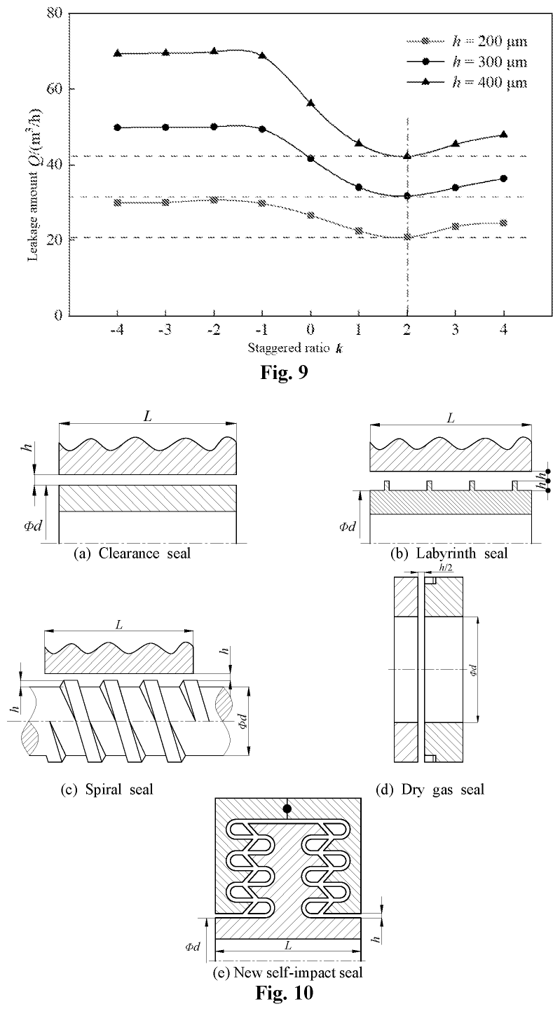

The proposed new non-contact self-impact seal efficient in throttling and fixed in clearance is arranged in a stacked manner, and series arrangement can be achieved. FIG. 10 shows typical structures of non-contact seals such as the clearance seal, the labyrinth seal, the spiral seal and the dry gas seal. It can be seen that these non-contact seal structures all have straight-through flow field channels, in which the fluid leaks unimpeded, resulting in the reduction of the sealing efficiency. Each stage of the flow field channel in the new seal has the impact blocking effect on the hedging fluid. The stage-by-stage impact blocking characteristic of the structure of the new seal makes the throttling efficiency more efficient. Table 1 shows a comparison of leakage of various types of non-contact mechanical seals. It can be seen that under the same working conditions, by taking the leakage amount as an index, the new seal reduces the leakage by 53%, 64% and 67% compared with the spiral, clearance and labyrinth seals of the same seal width.

TABLE 1
Comparison of leakage of non-contact mechanical seals (Sealing
distance h = 0.1 mm, pressure P = 0.2 MPa, speed
N = 10000 rpm, seal stage Z = 12, and seal width B = 34 mm)

| | Leakage amount | |
|---|---|---|
| Seal type | (m³/h) | Relative amplitude of variation |
| Spiral seal | 10.52 | 53% |
| Clearance seal | 13.77 | 64% |
| Labyrinth seal | 14.69 | 67% |
| Self-impact seal | 4.91 | — |

Table 2 shows a critical sealing distance of a self-impact seal under standard leakage (Q=0.4 m³/h) when the seal stages are different. It can be seen that the smaller the number of stages, the smaller the critical distance when achieving the standard leakage. When the stage is Z=6, 10 and 14, the corresponding critical distance is hₒ=32, 34 and 37 μm respectively, which is much higher than a normalized gas film condition of the dry gas seal (2-5 μm). This advantage greatly reduces the contact probability of the sealing pair, and is of great significance for improving the stability of the seal.

TABLE 2
Critical sealing distance hₒ of self-impact seal under standard leakage
(Pressure P = 0.2 MPa, speed N = 18000 rpm, medium air)

| Seal stage | Critical sealing distance (μm) |
|---|---|
| Z = 6 | 32 |
| Z = 10 | 34 |
| Z = 14 | 37 |

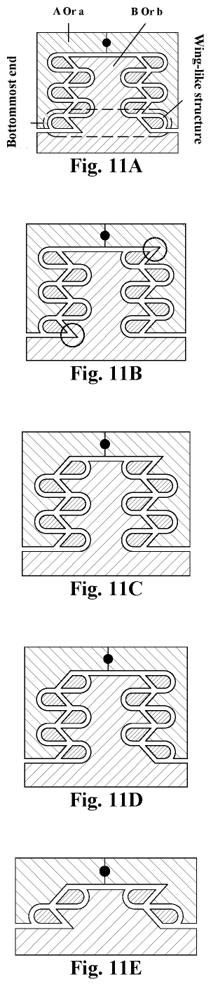

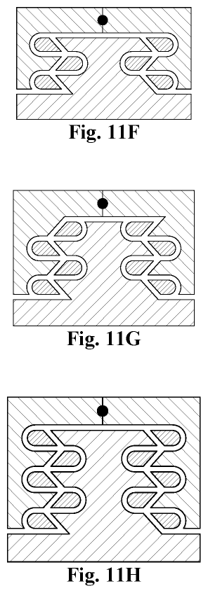

The application also studies and analyzes four stacked structural solutions, as shown in FIGS. 11A-11D, by taking a 10-stage seal as an example, the structure types of some stage units of the stationary ring and the rotating ring are defined to be in form of A(a) and B(b) respectively, where A and B indicate the existence of a wing-like structure at a bottommost end, and a and b indicate the absence of the wing-like structure at the bottommost end. Accordingly, the structural solutions in FIGS. 11A-11D are AbbA, AbBa, aBBa and aBbA, respectively, and this definition classification is suitable for all kinds of seal stages. As shown in FIGS. 11E-11H, which are corresponding 4-stage. 6-stage, 8-stage and 10-stage seal structures of the AbbA solution, it can be seen that the bottom end structures of the same solution are the same, the top structures of the seals are the same when a stage difference is 4, and the top structures of the seals are different when the stage difference is 2.

The leakage amount of four solutions under different seal stages (Z=4, 6, 8, 10) are respectively analyzed, and calculation results are shown in Table 3. It can be seen that when a stage interval is 4 (4 and 8, 6 and 10), the leakage performance of each solution is consistent. Specifically, when the stage is 4 and 8, the solutions are sorted as AbBa<aBBa<aBbA<AbbA according to the leakage size; and when the stage is 6 and 10, the solutions are sorted as AbBa<aBBa<AbbA<aBbA according to the leakage size. It can be seen that although the overall leakage sorting of different solutions is not exactly the same at different stages, the leakage of the solution AbBa is always the smallest, which may be caused by the fact that the stacked arrangement on both sides of this solution have a process of blocking and diverting the incoming flow (referring to FIG. 11B). The energy dissipation efficiency in this form is higher. Therefore, it is considered that the solution AbBa is the optimal structural solution for leakage suppression.

TABLE 3
Comparison of leakage of four solutions under different stages

| | AbbA | AbBa | aBBa | aBbA |
|---|---|---|---|---|
| Z = 4 | 55.05 | 51.25 | 52.39 | 53.81 |
| Z = 6 | 47.56 | 41.57 | 46.66 | 56.16 |
| Z = 8 | 45.01 | 40.63 | 41.66 | 44.99 |
| Z = 10 | 40.72 | 36.77 | 39.81 | 45.15 |

The above description of the disclosed embodiments enables those skilled in the art to implement or use the application. Various modifications to these embodiments will be apparent to those skilled in the art, and the general principles defined herein may be implemented in other embodiments without departing from the spirit or scope of the application. Therefore, the application will not be limited to the embodiments shown herein, but is within the widest scope consistent with the principles and novel features disclosed herein.

1. A non-contact self-impact seal efficient in throttling and fixed in clearance, wherein the non-contact self-impact seal is formed by assembling a stationary ring, a rotating ring and hanging pillars; the stationary ring, the rotating ring and the hanging pillars are all rigidly fixed; the hanging pillars are respectively arranged in the stationary ring or the rotating ring according to an assembly relationship; a fluid channel is formed by a non-contact clearance formed after the stationary ring, the rotating ring and the hanging pillars are rigidly fixed; the fluid channel is composed of an inlet, an outlet and a stacked arrangement structure, the stacked arrangement structure being composed of a plurality of self-impact units, and each self-impact unit specifically including a fluid channel body; and a first bifurcated opening of the fluid channel is divided into an oblique channel and a bent channel, and the bent channel is intersected with the oblique channel again to form a second bifurcated opening after large turning;
the arrangement of the self-impact units is composed of one or more combinations of symmetrical, positive staggered and negative staggered arrangements according to an arrangement relationship of the adjacent first bifurcated opening and the second bifurcated opening; when the positive staggered arrangement is adopted and a staggered ratio k=2, a solution is optimal, and the lowest leakage is achieved without making a seal stage unit too wide, wherein a staggered value represents a specific position of the fluid channel, the positive staggered arrangement is conducive to improving a leakage suppression effect, the seal leakage is the largest when the negative staggered arrangement is adopted, and the staggered ratio is a dimensionless characterization value that measures the amount of positive and negative staggered stage units.

2. The non-contact self-impact seal efficient in throttling and fixed in clearance as claimed in claim 1, wherein the stacked arrangement structure is specifically composed of the plurality of self-impact units through a series combination, and the series combination includes single-column or multi-column arrangement styles.

3. The non-contact self-impact seal efficient in throttling and fixed in clearance as claimed in claim 2, wherein in the multi-column arrangement, the stationary ring is designed into two parts that are connected by bolts or an interference fit, the middle is sealed with a seal ring, the hanging pillars are respectively arranged in the corresponding rotating ring and stationary ring, the entire assembly is axially completed in sequence, and during the multi-column arrangement, the stationary ring and the rotating ring are further split, and are connected in series as a whole.

4. The non-contact self-impact seal efficient in throttling and fixed in clearance as claimed in claim 2, wherein during assembly, the rotating ring is rigidly fixed to a shaft or a shaft sleeve by a set screw or a key or an interference fit connection, and the stationary ring is rigidly fixedly connected to a gland or a body by an anti-rotating pin or a key or an interference fit connection.

5. The non-contact self-impact seal efficient in throttling and fixed in clearance as claimed in claim 3, wherein through the adoption of the single-column or multi-column structural arrangement styles, the stationary ring and the rotating ring are axially mounted on the shaft or the shaft sleeve in sequence, or the seal is assembled as a whole, and then is directly mounted on the shaft or the shaft sleeve.
